(19) United States
(12) Patent Application Publication
(10) Pub. No.: US 2026/0038732 A1
(43) Pub. Date: Feb. 5, 2026

(54) COIL COMPONENT, METHOD FOR MANUFACTURING COIL COMPONENT, AND ELECTRONIC/ELECTRIC DEVICE

(71) Applicant: DELTA ELECTRONICS (JAPAN), INC., Tokyo (JP)

(72) Inventors: Akihiro YOSHIDA, TOKYO (JP); Shinji SUGIHARA, TOKYO (JP); Masumi SHIRAISHI, TOKYO (JP); Tatsuhara OTSUKA, TOKYO (JP); Michio KAMIMURA, TOKYO (JP)

(73) Assignee: DELTA ELECTRONICS (JAPAN), INC., Tokyo (JP)

(21) Appl. No.: 19/351,321

(22) Filed: Oct. 7, 2025

Related U.S. Application Data
(63) Continuation of application No. PCT/JP2023/014424, filed on Apr. 7, 2023.

(51) Int. Cl. H01F 27/29; H01F 27/32

(52) U.S. Cl. CPC H01F 27/29; H01F 27/32

(57) ABSTRACT

A coil component exhibiting excellent electric properties even when miniaturized is provided. It includes a coil member, which includes first and second spiral conductor portions aligned in a first direction, and a first insulator portion. The first insulator portion includes a portion contacting a first back counterpart, a portion contacting a second back counterpart, a portion contacting a side part of the first spiral conductive part in the spiral direction, and a portion contacting a side part of the second spiral conductive part in the spiral direction. The first insulating part includes a first connection part, which connects a portion in contact with a side part of a first turn included in the first spiral conductor portion to a portion in contact with a side part of a second turn, which is nearest to the side part of the first turn, in the second spiral conductor portion.

### CROSS REFERENCE TO RELATED APPLICATIONS

This application is a continuation application of PCT Application No. PCT/JP2023/014424, filed on Apr. 7, 2023. The content of the application is incorporated herein by reference.

### BACKGROUND OF THE INVENTION

### 1. Field of the Invention

The present invention relates to a coil component and a method for manufacturing the same. The present invention also relates to an electronic/electric device, in which the coil component is installed.

### 2. Description of the Related Art

Patent Document 1 (Japanese Patent Publication No. 2018-113434) discloses an inductor. The inductor includes a main body, which includes a supporting member, a coil supported by the supporting member, and a sealing material sealing the supporting member and the coil, and an external electrode disposed on the outer surface of the main body. The coil includes a plurality of coil patterns. Each of the plurality of coil patterns includes a first coil layer and a second coil layer disposed on the first coil layer. The sealing material includes magnetic powder and fills the space between adjacent ones of the plurality of coil patterns. The sealing material is disposed between the first coil layers and extends in a direction toward the supporting member, and the surfaces of the plurality of coil patterns are coated with an insulating layer.

In the disclosure of Patent Document 1, with regard to the inductor, the supporting member can be an insulating substrate made of an insulating resin. The insulating resin is exemplified to be “a thermosetting resin such as an poxy resin, thermoplastic resin such as polyimide, or a resin impregnated with a reinforcing material such as glass fiber or inorganic filler, e.g., prepreg, ABF (Ajinomoto Build-up Film), FR-4, BT (Bismaleimide Triazine) resin, and PID (Photo Imageable Dielectric) resin.”

The inductor disclosed in Patent Document 1 has a considerable degree of rigidity because it is a supporting substrate, and thus occupies a certain amount of volume within the inductor. The insulating resin mentioned in the above example has a low relative magnetic permeability and thus does not function in terms of improving the electric characteristics of the inductor. Therefore, the presence of the supporting substrate might be an obstacle to improvement of the functionality of the inductor. The impact of this obstacle is even more serious for miniaturization of the inductor.

### SUMMARY OF THE INVENTION

An object of the present invention is to provide a coil component, which can exhibit excellent electric properties even when miniaturized. In addition, objects of the present invention are to provide a method for manufacturing the coil component, and an electronic/electric device, in which the coil component is installed.

The inventors conducted research to solve the above-mentioned newly discovered problems, and discovered that by providing insulating members connecting the plurality of coil patterns in lieu of the supporting substrate disposed among the coil patterns, a coil component with excellent electric properties can be provided.

In an embodiment of the present invention provided based on the above findings, the coil component may include a coil member, which includes a first spiral conductor portion and a second spiral conductor portion, aligned with each other in a first direction; and a first insulator portion. The first insulator portion includes a part in contact with a back counterpart of the first spiral conductor portion, which is opposite to the second spiral conductor portion (the part at the side opposite to the side facing the second spiral conductor portion); a part in contact with a back counterpart of the second spiral conductor portion, which is opposite to the first spiral conductor portion (the part at the side opposite to the side facing the first spiral conductor portion); a part in contact with a side part of the first spiral conductor portion along a spiral direction thereof; and a part in contact with a side part of the second spiral conductor portion along a spiral direction thereof. The first insulator portion includes a first connection part disposed to connect a part in contact with a side part of a first turn of the first spiral conductor portion to a part in contact with a side part of a second turn of the second spiral conductor portion, which is closest to the side part of the first turn.

The coil component may include a main body portion, which contains a magnetic powder and covers at least partially the coil member; and two terminal members, which are electrically connected to two end parts of the coil member, respectively. The coil member includes the first spiral conductor portion and the second spiral conductor portion and has a conductive coil conductor portion. The coil conductor portion includes a via member disposed between an end part of the first spiral conductor portion and an end part of the second spiral conductor portion to be in contact with the end part of the first spiral conductor portion and the end part of the second spiral conductor portion; a first lead part electrically connected one of the two terminal members to another end part of the first spiral conductor portion; and a second lead part electrically connected the other of the two terminal members to another end part of the second spiral conductor portion.

In the coil component, the first insulator portion may include a part in contact with a counterpart of the first spiral conductor portion, which faces the second spiral conductor portion; and a part in contact with a counterpart of the second spiral conductor portion, which faces the first spiral conductor portion.

In the coil component, the first insulator portion may be in contact with a portion of the coil conductor portion, which is located inside the main body portion. Specifically, the first insulator portion, for all turns of the first spiral conductor portion, may include a portion in contact with a counterpart, a portion in contact with a back counterpart, and a portion in contact with a side of the second spiral conductor portion, and for all turns of the second spiral conductor portion, may include a portion in contact with a counterpart, a portion in contact with a back counterpart, and a portion in contact with a side of the first spiral conductor portion.

In the coil component, at least one of the first spiral conductor portion and the second spiral conductor portion comprises two turns aligned with each other in a direction intersecting the first direction, and the first insulator portion in contact with one of the two opposing side parts of the two turns and the first insulator portion in contact with the other of the two opposing side parts may be in contact with each other or integrated.

In the coil component, each of the first spiral conductor portion and the second spiral conductor portion may include two turns aligned with each other in a direction intersecting the first direction, the first connection part exists in each of the two turns, and the two first connection parts existing in the two turns are in contact with each other with a boundary or integrated with each other.

In the coil component, at least one of the two first connection parts may include at least one of a part connected to the counterpart of the first spiral conductor portion and a part connected to the counterpart of the second spiral conductor portion.

In the coil component, the first insulator portion may include a thermoplastic resin and is thermoplastic. In an embodiment, the thermoplastic resin may include a paraxylylene-based polymer.

In the coil component, for the first insulator portion, a volume resistivity measured according to ASTM D257 is 1.0×10¹⁴ Ωcm or more, and a relative dielectric constant at 60 Hz measured according to ASTM D150 is 4.0 or less.

In the coil component, oxide-based particles may be present between the first spiral conductor portion and the second spiral conductor portion.

In the coil component, the oxide-based particles may have an average equivalent circular diameter ranged between 0.0010 μm and 2.5 μm when viewed from a cross section between the first spiral conductor portion and the second spiral conductor portion.

In the coil component, an average clearance between the first spiral conductor portion and the second spiral conductor portion may be ranged between 1.0 μm and 20 μm.

In the coil component, for the first insulator portion, an average thickness of a thickness of a portion of the first spiral conductor portion in contact with a back counterpart of the second spiral conductor portion, a thickness of a portion of the second spiral conductor portion in contact with an opposite side of the first spiral conductor portion, a thickness of a portion of the first spiral conductor portion in contact with a side part of the second spiral conductor portion, and a thickness of a portion of the second spiral conductor portion in contact with a side part of the first spiral conductor portion is ranged between 1.0 μm and 10 μm.

In the coil component, at least one of the first spiral conductor portion and the second spiral conductor portion may include two turns aligned with each other in a direction intersecting the first direction. The first insulator portion may include a specified portion in contact with one of the two turns; a specified portion in contact with the other of the two turns; and a second connection part continuously extending from the specified portions in the direction intersecting the first direction. The second connection part may have a thinned part, which is thinner, in the first direction, than the specified portion of the first insulator portion in contact with either of the two turns.

In the coil component, at least one of the first spiral conductor portion and the second spiral conductor portion may include two turns aligned with each other in a direction intersecting the first direction, and an average width of a gap between the two turns may be 0.025 to 0.25 times an average width of the two turns in the direction intersecting the first direction.

In the coil component, the first insulator portion may include an intermediate part disposed between a turn of the first spiral conductor portion and a turn of the second spiral conductor portion, and at least one of a boundary surface or air pores exists in the intermediate part.

In the coil component, at least one of the first spiral conductor portion and the second spiral conductor portion comprises two turns aligned with each other in a direction intersecting the first direction, and the first insulator portion exists in each of the two opposing side parts of the two turns, and at least one of a line boundary and a closed space exists in between the side parts of the two turns and the first insulator portion.

In the coil component, the first insulator portion in contact with the first spiral conductor portion, for all turns of the first spiral conductor portion, a specified portion in contact with a counterpart facing the second spiral conductor portion, a specified portion in contact with a back counterpart opposite to the second spiral conductor portion, and a specified portion in contact with a side may be continuously interconnected without a connection boundary.

In the coil component, the first insulator portion in contact with a counterpart of the first spiral conductor portion facing the second spiral conductor portion may also be in contact with the second spiral conductor portion without a connection boundary.

In the coil component, a second insulator portion may be formed of a material different from the material forming the first insulator portion and is disposed at least partially between the first spiral conductor portion and the second spiral conductor portion. The second insulator portion may include a polyimide resin.

In the coil component, the second insulator portion may be in contact with at least one of the first spiral conductor portion and the second spiral conductor portion.

In another embodiment of the present invention, a method for manufacturing a coil component, wherein the coil component includes a coil member, and the coil member includes a first spiral conductor portion and a second spiral conductor portion aligned with each other in a first direction and a first insulator portion, may include a first step of forming the first spiral conductor portion on a surface of an insulating sheet substrate, and forming the second spiral conductor portion on another surface of the sheet substrate; a second step of removing at least partially the sheet substrate; and a third step of forming the first insulator portion to be in contact with exposed surfaces of the first spiral conductor portion and the second spiral conductor portion.

In the method for manufacturing the coil component, the coil component may further include a main body portion comprising a magnetic powder and covering at least partially the coil member; and two terminal members electrically connected to two end parts of the coil member, respectively. The coil member may include a via member disposed between an end part of the first spiral conductor portion and an end part of the second spiral conductor portion to be in contact with the end part of the first spiral conductor portion and the end part of the second spiral conductor portion; a first lead part electrically connected one of the two terminal members to another end part of the first spiral conductor portion; and a second lead part electrically connected the other of the two terminal members to another end part of the second spiral conductor portion. In the first step, the first lead part and the second lead part as well as the via member are formed. The method may further include a fourth step of forming the main body portion by sealing the coil member except for a portion of the first lead part and a portion of the second lead part with a material containing the magnetic powder; and a fifth step of electrically connecting one of the two terminal members to the portion of the first lead part, which is not sealed with the material containing the magnetic powder in the fourth step, and electrically connecting the other of the two terminal members to the portion of the second lead part, which is not sealed with the material containing the magnetic powder in the fourth step.

In the method for manufacturing the coil component, in the second step, the sheet substrate is completely removed.

In the method for manufacturing the coil component, in the first step, the first spiral conductor portion and the second spiral conductor portion as well as the via member are formed by a plating process.

In a further embodiment of the present invention, an electronic/electric device, where the coil component is installed, and the coil component is connected to a board via the terminal members, is provided. Examples of the electronic/electric device may include a power supply and a small portable communication device equipped with a power switching circuit, a voltage step-up circuit, a smoothing circuit, etc. The electronic/electric device according to the present invention is excellent in terms of performance and dimensions because it is equipped with the above-mentioned coil component.

The present invention provides a coil component, which is adapted to miniaturization and still has excellent magnetic properties. An electronic/electric device equipped with the coil component can also be miniaturized, while exhibiting improved performance. The present invention also provides an electronic/electric device, in which the coil component is installed.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a perspective view schematically illustrating a concept of a shape of a coil component according to an embodiment of the present invention.

FIG. 2 is a schematic diagram illustrating a structure of two conductor portions included in a coil component according to an embodiment of the present invention.

FIG. 3 is an XY plan view illustrating a structure of a first spiral conductor portion included in a coil component according to an embodiment of the present invention.

FIG. 4 is an XY plan view illustrating a structure of a second spiral conductor portion included in a coil component according to an embodiment of the present invention.

FIG. 5 is an XY plan view and a cross-sectional view in the XZ plane illustrating the structure of a coil member included in a coil component according to one embodiment of the present invention.

FIG. 6 is a cross-sectional view on an XZ plane for illustrating a first embodiment of a first insulator portion included in a coil component according to an embodiment of the present invention.

FIG. 7 is a schematic diagram illustrating a detailed structure (first example) of a first insulator portion included in a coil component according to an embodiment of the present invention.

FIG. 8 is a schematic diagram illustrating a detailed structure (second example) of a first insulator portion included in a coil component according to an embodiment of the present invention.

FIG. 9 is a schematic diagram illustrating a detailed structure (third example) of a first insulator portion included in a coil component according to an embodiment of the present invention.

FIG. 10 is a schematic diagram illustrating a detailed structure (fourth example) of a first insulator portion included in a coil component according to an embodiment of the present invention.

FIG. 11 is a schematic diagram illustrating a detailed structure (first modification of second example) of a first insulator portion included in a coil component according to an embodiment of the present invention.

FIG. 12 is a schematic diagram illustrating a detailed structure (second modification of second example) of a first insulator portion included in a coil component according to an embodiment of the present invention.

FIG. 13 is a schematic diagram illustrating a detailed structure (third modification of second example) of a first insulator portion included in a coil component according to an embodiment of the present invention.

FIG. 14 is a cross-sectional view on an XZ plane for illustrating a second embodiment of a first insulator portion included in a coil component according to an embodiment of the present invention.

FIG. 15 is an XY plan view for illustrating the second embodiment of the first insulator portion.

FIG. 16 is a schematic diagram (former half) illustrating a method for manufacturing a coil component according to an embodiment of the present invention.

FIG. 17 is a schematic diagram (latter half) illustrating a method for manufacturing a coil component according to an embodiment of the present invention.

FIG. 18 is a schematic diagram illustrating a modified structure of a coil conductor portion included in a coil component according to an embodiment of the present invention.

### DETAILED DESCRIPTION

Below, embodiments according to the present invention will be described in detail with reference to the drawings.

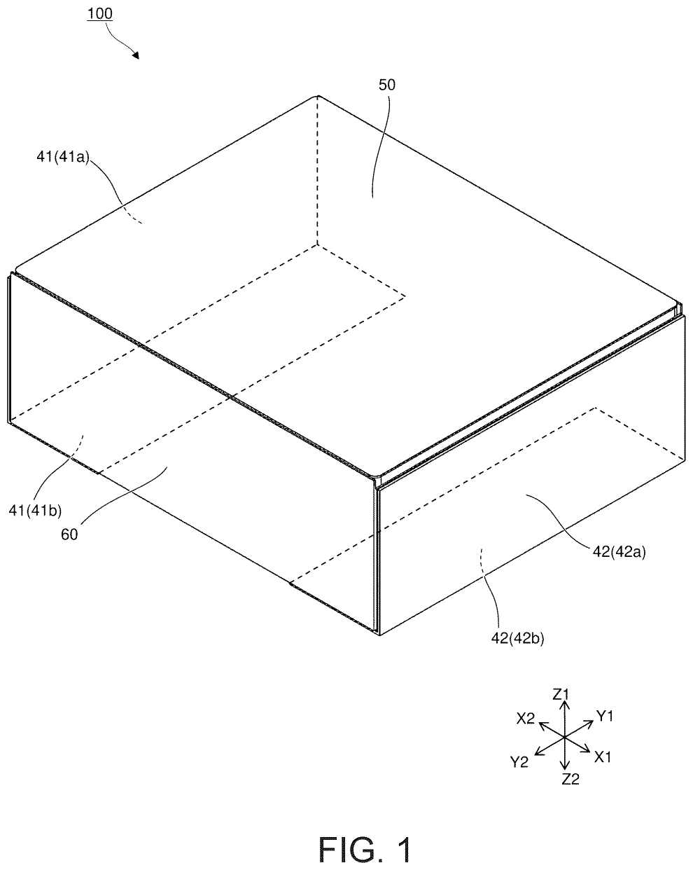

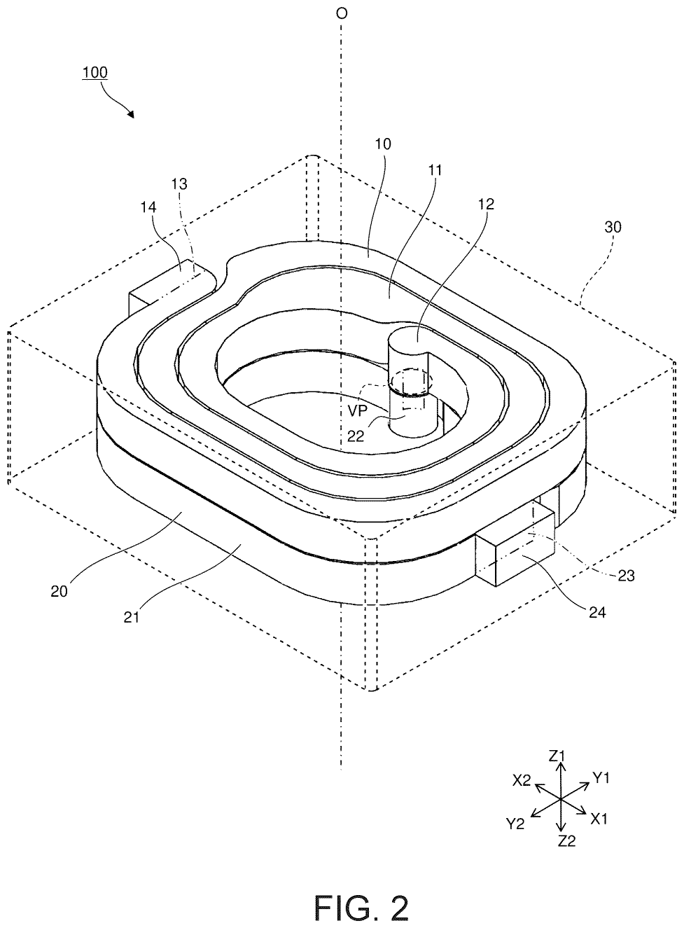

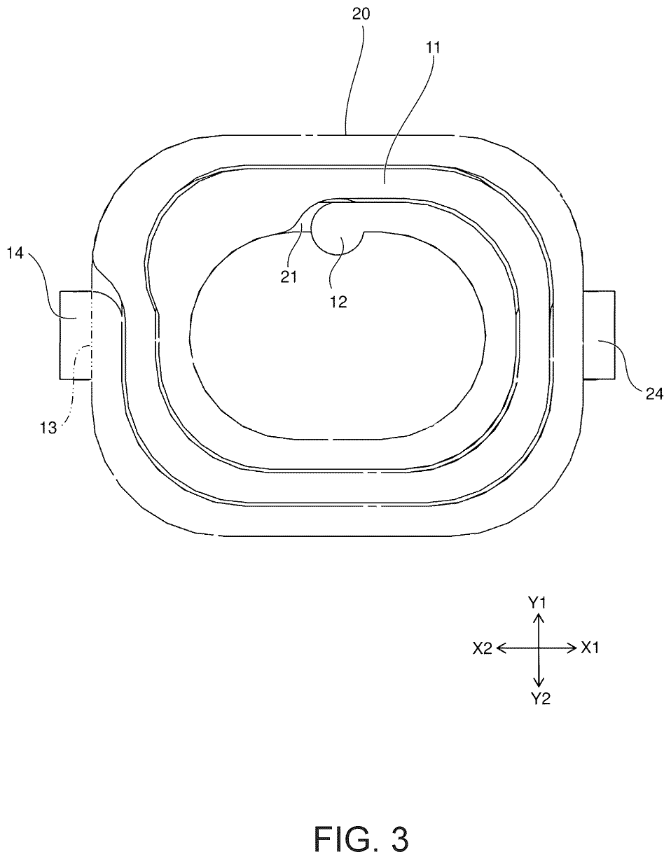

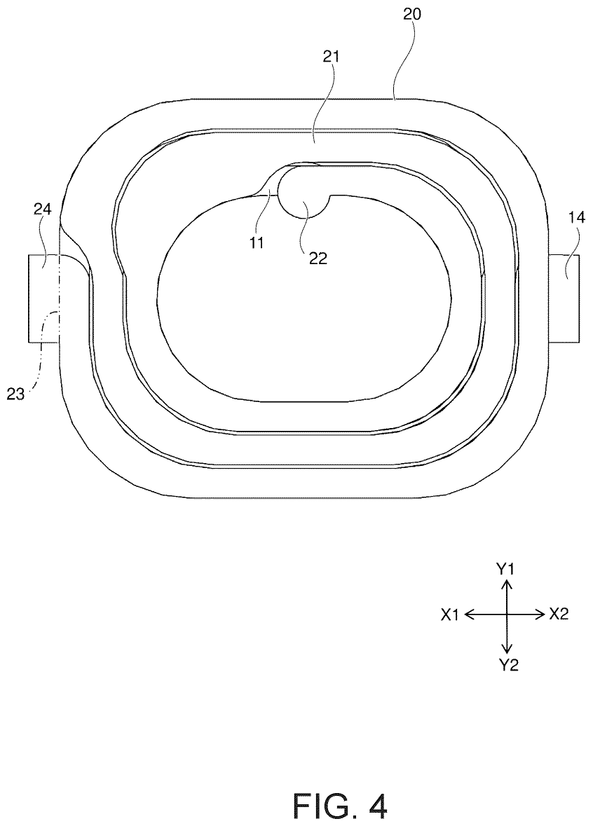

FIG. 1 is a perspective view schematically illustrating a concept of a shape of a coil component according to an embodiment of the present invention. FIG. 2 is a schematic diagram illustrating a structure of two spiral portions included in a coil component according to an embodiment of the present invention. In FIG. 2, for readily understanding, the coil conductor portion is drawn with a solid line while the main body portion is drawn with a dashed line, and the other components are omitted from the drawing. FIG. 3 is an XY plan view illustrating a structure of a first spiral conductor portion included in a coil component according to an embodiment of the present invention. FIG. 4 is an XY plan view illustrating a structure of a second spiral conductor portion included in a coil component according to an embodiment of the present invention. FIG. 3 is a view of the coil conductor portion seen from the Z1 side in the Z1-22 direction, and FIG. 4 is a view of the coil conductor portion seen from the Z2 side in the Z1-22 direction.

### (Overall Structure)

A coil component 100 according to one embodiment of the present invention includes a coil member 10, which includes a coil conductor portion 20, a main body portion 30, a first terminal member 41, a second terminal member 42, and outer covers 50 and 60.

### (Coil)

As shown in FIG. 2 and FIG. 3, the coil member 10 includes a coil conductor portion 20. The coil conductor portion 20 includes a first spiral conductor portion 11, which is shaped as a spiral extending from an inner-side end part 12 of the first spiral conductor portion 11 toward an outer-side end part 13 of the first spiral conductor portion 11 around an axis O in parallel to a first direction, i.e., the Z1-22 direction, and moves away from the axis O. As shown in FIG. 2, the first spiral conductor portion 11 viewed from the Z1 side in the Z1-22 direction is configured as a spiral-shaped conductor, which extends clockwise from the inner-side end part 12 toward the outer-side end part 13 and move away from the axis O. In this disclosure, the “spiral direction” of the spiral portion means the direction from the end on the inner-side end part to the outer-side end part.

The conductor (conductive material) used for forming the coil conductor portion 20 is not limited as long as it has appropriate conductivity. Specific examples of the conductor used for forming the coil conductor portion 20 include copper, copper alloys, aluminum, and aluminum alloys. The coil conductor portion 20 can be manufactured by any suitable film forming technique, for example, plating. The coil member 10 has an insulating coil insulator portion (not shown in FIGS. 1-4) located on a surface of the coil conductor portion 20. With the coil insulator portion, insulation between adjacent conductors (between surfaces of conductors facing each other) in the coil conductor portion 20 can be ensured. The coil insulator portion may be made of, for example, a resin material. The coil insulator portion is not provided at the ends of the two ends (first lead part 14, second lead part 24) of the coil conductor portion 20, and the coil member 10 can be electrically connected to other members at these ends.

As shown in FIGS. 2 and 4, the coil conductor portion 20 includes a second spiral conductor portion 21, which is allocated in alignment with the first spiral conductor portion 11 in the first direction. The second spiral conductor portion 21 is shaped as a spiral extending from an inner-side end part 22 of the second spiral conductor portion 21 toward an outer-side end part 23 of the second spiral conductor portion 21 around an axis O in parallel to the first direction, i.e., the Z1-22 direction, and moves away from the axis O. The second spiral conductor portion 21 viewed from the Z1 side in the Z1-22 direction is configured as a spiral conductor, which extends in a direction opposite to the first spiral conductor portion 11 (in FIG. 2, counterclockwise) and move away from the axis O. The average value of the clearance in the first direction (Z1-22 direction) between the first spiral conductor portion 11 and the second spiral conductor portion 21 is not particularly limited. The smaller the clearance is, the easier the reduction of the height (dimension in Z1-22 direction) of the coil component 100 could be. However, if the clearance is too small, the insulation between the first spiral conductor portion 11 and the second spiral conductor portion 21 is likely deteriorated. From the viewpoint of achieving both a low profile (low height) of the coil component 100 and high insulation between the first spiral conductor portion 11 and the second spiral conductor portion 21, it may be preferable that the clearance is ranged between 0.4 μm and 20 μm. In order to reduce variation in the clearance and more reliably support the coil in the same plane in terms of manufacturing, it is more preferable that the clearance is 1.0 μm or more, and even more preferable, 5.0 μm or more.

The end part 12 of the first spiral conductor portion 11 and the end part 22 of the second spiral conductor portion 21 are electrically connected through a via member VP. The via member VP may be made of the same conductor as the coil conductor portion 20. In a specific example, the via member VP is made of the same material as the first spiral conductor portion 11 and the second spiral conductor portion 21, and is manufactured simultaneously with the first spiral conductor portion 11 and the second spiral conductor portion 21. In this case, the via member VP is integrated with the end part 12 of the first spiral conductor portion 11 and the end part 22 of the second spiral conductor portion 21.

The first lead portion 14 is connected to the end part 13 of the first spiral conductor portion 11, and the second lead portion 24 is connected to the end part 23 of the second spiral conductor portion 21. Therefore, the end part 13 of the first spiral conductor portion 11 is essentially an interface with the first lead portion 14, and the end part 23 of the second spiral conductor portion 21 is essentially an interface with the second lead portion 24. In a specific example, the first lead portion 14 and the second lead portion 24 are made of the same material as the first spiral conductor portion 11 and the second spiral conductor portion 21, and are manufactured simultaneously with the first spiral conductor portion 11 and the second spiral conductor portion 21. In this case, the first lead portion 14 is integrated with the end part 13 of the first spiral conductor portion 11 without a boundary, and the second lead portion 24 is integrated with the end part 23 of the second spiral conductor portion 21 without a boundary.

In other words, in this embodiment, the coil conductor portion 20 includes the first spiral conductor portion 11 and the second spiral conductor portion 21, the via member VP, the first lead portion 14 and the second lead portion 24, which are formed of the same conductive material.

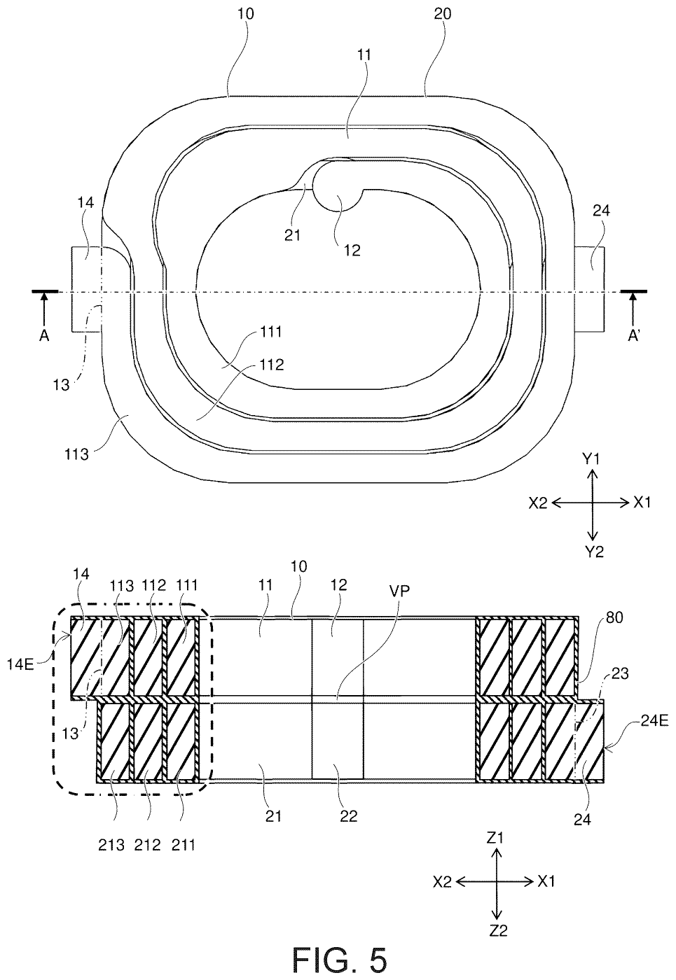

FIG. 5 is an XY plan view and a cross-sectional view in the XZ plane (XZ cross-sectional view) illustrating the structure of a coil member included in a coil component according to one embodiment of the present invention. Only the coil conductor portion 20 is depicted in the XY plan view of FIG. 5, and a cross section taken along line A-A′ in the XY plan view is shown as the XZ cross-sectional view. In the XZ cross-sectional view, elements except for the coil conductor portion 20 are seen through.

As shown in the cross section of FIG. 5, each turn of the first spiral conductor portion 11 and each turn of the second spiral conductor portion 21 are positioned so as to be aligned in the first direction. The first spiral conductor portion 11 includes a first inner-side turn 111 located on the innermost side, a first outer-side turn 113 located on the outermost side, and a first intermediate turn 112 located between them. The second spiral conductor portion 21 includes a second inner-side turn 211 located on the innermost side, a second outer-side turn 213 located on the outermost side, and a second intermediate turn 212 located between them.

The second inner-side turn 211 is located on the Z2 side of the first inner-side turn 111 in the Z1-22 direction, the second outer-side turn 213 is located on the Z2 side of the first outer turn 113 in the Z1-22 direction, and the second intermediate turn 212 is located on the Z2 side of the first intermediate turn 112 in the Z1-22 direction. In the coil member 10 shown in FIG. 5, the second lead portion 24 is not present on the Z2 side of the end part 13 of the first spiral conductor portion 11 in the Z1-22 direction, and the first lead section 14 is not present on the Z1 side of the end part 23 of the second spiral conductor portion 21 in the Z1-22 direction.

### First Embodiment

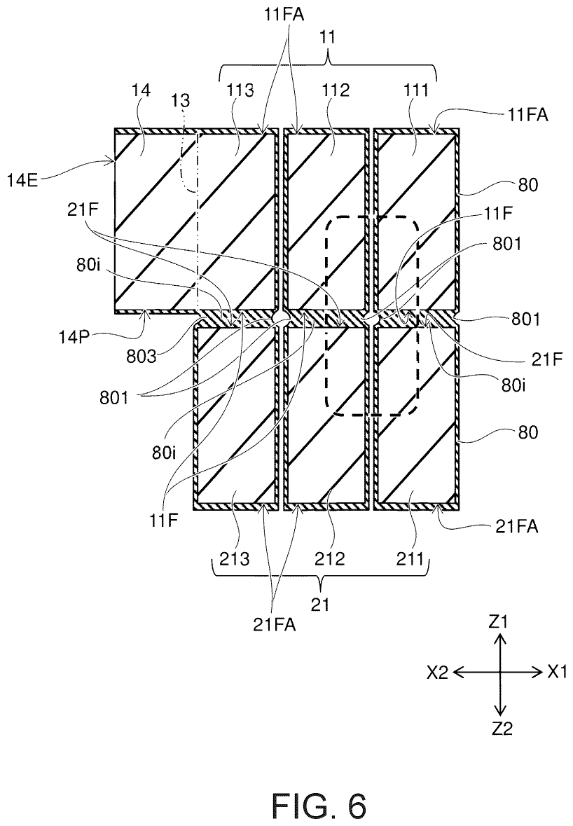

A coil insulator portion included in the coil component 100 according to an embodiment of the present invention will be described in detail hereinafter with reference to FIGS. 6-13, which are enlarged views of the area surrounded by the dashed line shown on the X2 side in the X1-X2 direction in the cross-sectional view of FIG. 5. FIG. 6 is an XZ cross-sectional view illustrating a first embodiment of a first insulator portion included in a coil component according to an embodiment of the present invention.

The coil insulator portion has a first insulator portion 80, and as shown in FIG. 6, the first insulator portion 80 is provided on at least a portion of the surface of the first spiral conductor portion 11 and the surface of the second spiral conductor portion 21.

In this embodiment, the first insulator portion 80 is thermoplastic and contains a thermoplastic resin including a para-xylylene-based polymer. Other examples of the thermoplastic resin include polyethylene, polypropylene, polyamide, polyester, polyamideimide, polyimide, polysulfone, polycarbonate, liquid crystal polymer, polyvinylidene fluoride, polytetrafluoroethylene, etc. The first insulator portion 80, as a whole, is only required to have thermoplastic properties, and in addition to the above-mentioned thermoplastic resin, it may contain, for example, inorganic insulating particles.

It is preferable that the first insulator portion 80 has excellent insulation properties, and specifically, in some cases, it is preferable that the volume resistivity measured according to ASTM D257 is 1.0×10¹⁴ Ωcm or more. This volume resistivity is more preferably 1.0×10¹⁵ Ωcm or more, and even more preferably 1.0×10¹⁶ Ωcm or more. The upper limit of the volume resistivity is not particularly limited. The volume resistivity may be 1.0×10²⁰ Ωcm or less. In addition, it is preferable that the first insulator portion 80 has excellent dielectric properties, and specifically, in some cases, it is preferable that the relative dielectric constant at 60 Hz measured according to ASTM D150 is 4.0 or less. The relative dielectric constant of the first insulator portion 80 is, more preferably, 3.5 or less, even more preferably, 3.0 or less. The lower limit of the relative dielectric constant is not particularly limited. The relative dielectric constant may be 1.0 or more. The method for measuring the volume resistivity and the relative dielectric constant of the first insulator portion 80 is not limited as long as the results show equivalent effects to those determined according to the above-mentioned ASTM D257 and ASTM D150. For example, a measurement sample is additionally prepared by formulating a material equivalent to the first insulator portion 80 with the dimensions required for measurement, and the constituent materials are identified using analytical techniques such as component analysis and FT-IR with the measurement sample. Then the features of the material, such as volume resistivity, are evaluated.

The first insulator portion 80 includes a part in contact with a part of the first spiral conductor portion 11, which is opposite to the side facing the second spiral conductor portion 21, i.e., a back counterpart (first back counterpart 11FA) of the first spiral conductor portion 11 opposite to the second spiral conductor portion 21. In FIG. 6, the ends of the first inner-side turn 111, the first intermediate turn 112, and the first outer-side turn 113, and furthermore, the first lead portion 14 connected to the first outer-side turn 113 on the Z1 side in the Z1-Z2 direction are the first back counterpart 11FA, and the first insulator portion 80 disposed on the first back counterpart 11FA is the above-mentioned part.

The first insulator portion 80 includes a part in contact with a back counterpart (second back counterpart 21FA) of the second spiral conductor portion 21 opposite to the first spiral conductor portion 11. In FIG. 6, the ends of the second inner-side turn 211, the second intermediate turn 212, and the second outer-side turn 213 on the Z2 side in the Z1-22 direction are the second back counterpart 21FA, and the first insulator portion 80 includes a part connected to the second back counterpart 21FA.

The first insulator portion 80 includes a part in contact with a side part of the first spiral conductor portion 11 along the spiral direction. In a case that the first inner-side turn 111 is exemplified to illustrate the side part, there is a side part facing the inner side (X1 side in X1-X2 direction) and a side part facing the outer side (X2 side in X1-X2 direction) and opposite to the first intermediate turn 112 in the first inner-side turn 111. The first insulator portion 80 includes a part in contact with these side parts. The first insulator portion 80 is not provided on the side part on the outer side (X2 side in X1-X2 direction) of the end part 13 of the first spiral conductor portion 11 in order that it can be electrically connected to another member (first terminal member 41).

The first insulator portion 80 includes a part in contact with a side part of the second spiral conductor portion 21 along the spiral direction. In a case that the second inner-side turn 211 is exemplified to illustrate the side part, there is a side part facing the inner side (X1 side in X1-X2 direction) and a side part facing the outer side (X2 side in X1-X2 direction) and opposite to the second intermediate turn 212 in the second inner-side turn 211. The first insulator portion 80 includes a part in contact with these side parts. Although not shown, the first insulator portion 80 is not provided on the side part on the outer side (X2 side in X1-X2 direction) of the end part 23 of the second spiral conductor portion 21 in order that it can be electrically connected to another member (second terminal member 42).

From the viewpoint of stably providing the first insulator portion 80 on the side parts, it may be preferable that the average width of the gap between two turns aligned in a direction (XY in-plane direction) intersecting the first direction (Z1-Z2 direction) is 0.025 to 0.25 times the average width of the two turns aligned in the alignment direction.

In the first insulator portion 80, an average value of the thickness of the part in contact with the first back counterpart 11FA (the part of the first spiral conductor portion 11 opposite to the side facing the second spiral conductor portion 21), the thickness of the part in contact with the second counterpart 21FA (the part of the second spiral conductor portion 21 opposite to the side facing the first spiral conductor portion 11), the thickness of the part in contact with the side of the first spiral conductor portion 11, and the thickness of the part in contact with the side of the second spiral conductor portion 21, may preferably be ranged between 0.2 μm and 10 μm, from the viewpoint of providing the first insulator portion 80 with good insulation properties. From the viewpoint of ensuring stable insulation properties, the average value is more preferably 1.0 μm or more.

The first insulator portion 80 includes a first connection part 801 disposed for connecting a part in contact with a side part of a first turn, which may be at least one of the turns included in the first spiral conductor portion 11 (in this embodiment, the first inner-side turn 111, the first intermediate turn 112, and the first outer-side turn 113) to a part in contact with a side part of a second turn, which is closest to the side part of the first turn. From the viewpoint of stable formation of the first connection part 801, it may be preferable that the average value of the clearance in the first direction (Z1-22 direction) between the first spiral conductor portion 11 and the second spiral conductor portion 21 is ranged between 0.4 μm and 20 μm.

In a specific example, when the first turn is the first inner-side turn 111, the second turn, which is closest to the side part of the first turn (first inner-side turn 111) in the second spiral conductor portion 21, is the second inner-side turn 211. The first insulator portion 80 disposed to connect the first insulator portion 80 in contact with the side part of the inner side (X1 side in X1-X2 direction) of the first inner-side turn 111 to the first insulator portion 80 in contact with the side part of the inner side (X1 side in X1-X2 direction) of the second inner-side turn 211 is the first connecting portion 801.

If is further shown in FIG. 6 a first connection part 801 connecting the first insulator portion 80 in contact with the side part of the outer side (X2 side in X1-X2 direction) of the first inner-side turn 111 to the first insulator portion 80 in contact with the side part of the outer side (X2 side in X1-X2 direction) of the second inner-side turn 211, a first connection part 801 connecting the first insulator portion 80 in contact with the side part of the inner side (X1 side in X1-X2 direction) of the first intermediate turn 112 to the first insulator portion 80 in contact with the side part of the inner side (X1 side in X1-X2 direction) of the second intermediate turn 212, a first connection part 801 connecting the first insulator portion 80 in contact with the side part of the outer side (X2 side in X1-X2 direction) of the first intermediate turn 112 and the first insulator portion 80 in contact with the side part of the outer side (X2 side in X1-X2 direction) of the second intermediate turn 212, and a first connection part 801 in contact with the first insulator portion 80 in contact with the side part of the inner side (X1 side in X1-X2 direction) of the first outer-side turn 113 and the first insulator portion 80 in contact with the side part of the inner side (X1 side in X1-X2 direction) of the second outer-side turn 213.

In this way, with the first connection part 801, the volume of the coil insulator portion could be reduced, thereby making it easier to improve the electric features of the coil component 100 and to meet the demand for miniaturization of the coil component 100.

The first insulator portion 80 includes a part in contact with a counterpart (first counterpart 11F) of the first spiral conductor portion 11 facing the second spiral conductor portion 21, and a part in contact with a counterpart (second counterpart 21F) of the second spiral conductor portion 21 facing the first spiral conductor portion 11. In the first insulator portion 80 shown in FIG. 6, these parts are integrated to form intermediate parts 80i, and the intermediate parts 80i and the first connection part 801 are integrated. In the intermediate parts 80i, the first insulator portion 80 in contact with the counterpart (first counterpart 11F) of the first spiral conductor portion 11 facing the second spiral conductor portion 21 also contacts the second spiral conductor portion 21 without a connection boundary. By providing such a configuration, it is easy to improve the insulation between the first spiral conductor portion 11 and the second spiral conductor portion 21.

The first insulator portion 80 in contact with the side part of the outer side (X2 side in X1-X2 direction) of the second outer-side turn 213 includes a third connection part 803, which connects the first insulator portion 80 in contact with a first extension part 14P of the first lead portion 14 on the Z2 side in the Z1-22 direction and extending from the first counterpart 11F of the first outer-side turn 113, to the first insulator portion 80 in contact with the side part of the outer side (X2 side in X1-X2 direction) of the second outer-side turn 213.

The first insulator portion 80 shown in FIG. 6 contacts a part of the coil conductor portion 20 located inside the main body portion 30. Specifically, the first insulator portion 80 is configured to be in contact with a part of the coil conductor portion 20 except for an end part (first lead portion end surface 14E) on the outer side (X2 side in X1-X2 direction) of the first lead portion 14 and an end part (second lead portion end surface 24E, not shown in FIG. 6) on the outer side (X1 side in X1-X2 direction) of the second lead portion 24. In this way, even if the surface of the magnetic powder contained in the main body portion 30 is conductive, unexpected short circuits occurring in the coil conductor portion 20 can be stably avoided as the coil conductor portion 20 contacts the magnetic powder.

From the viewpoint of more stably preventing short circuit in the coil conductor portion 20, it is preferable for the first insulator portion 80 that for all turns of the first spiral conductor portion 11, the part in contact with the counterpart (first counterpart 11F) facing the second spiral conductor portion 21, the part in contact with the back counterpart (first back counterpart 11FA) opposite to the second spiral conductor portion 21, and the part in contact with the side are continuously interconnected without a connection boundary. Likewise, it is preferable for the first insulator portion 80 in contact with the second spiral conductor portion 21 that for all turns of the second spiral conductor portion 21, the part in contact with the counterpart (second counterpart 21F) facing the first spiral conductor portion 11, the part in contact with the back counterpart (second back counterpart 21FA) opposite to the first spiral conductor portion 11, and the part in contact with the side are continuously interconnected without a connection boundary.

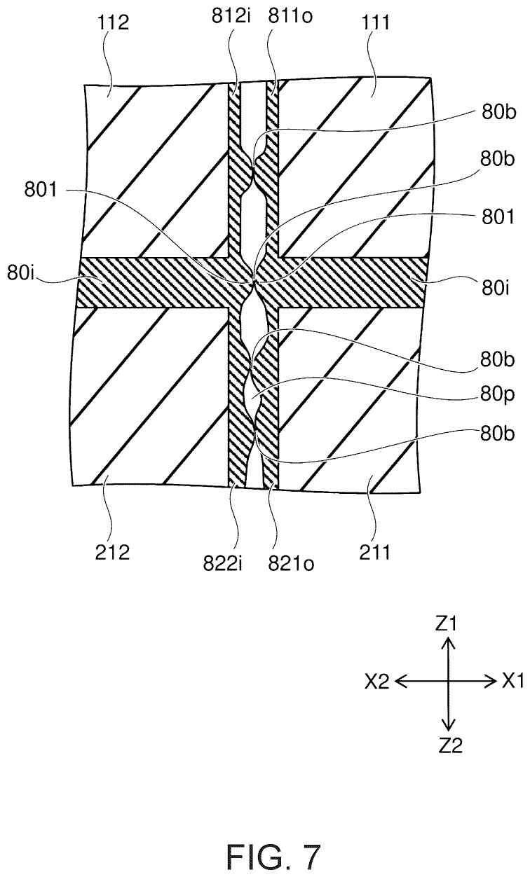

The detailed structure of the first insulator portion 80 in the first embodiment will be described below with reference to FIGS. 7-13, which are enlarged views of the area surrounded by the dashed line in FIG. 6. That is, FIGS. 7-13 are all views for illustrating the detailed structure of the first insulator portion 80 in the first embodiment. In each of these figures, at least one of the first spiral conductor portion 11 and the second spiral conductor portion 21 has two turns aligned in the X1-X2 direction, which is a direction intersecting the first direction (Z1-22 direction). Specifically, the first spiral conductor portion 11 includes a first inner-side turn 111 and a first intermediate turn 112, and the second spiral conductor portion 21 includes a second inner-side turn 211 and a second intermediate turn 212.

### First Example

FIG. 7 is a schematic diagram illustrating a detailed structure (first example) of a first insulator portion included in a coil component according to an embodiment of the present invention. In the first specific example, a first insulator portion 80 in contact with one of two opposite side parts in two turns contacts a first insulator portion 80 in contact with the other of the two side parts, and two first connection parts 801 present in the two turns are in contact with each other with a boundary surface 80b.

Specifically, a first insulator portion 8110 in contact with the outer side (X2 side in X1-X2 direction) of the first inner-side turn 111 includes one part in contact with a first insulator portion 812i, which is in contact with the inner side (X1 side in X1-X2 direction) of the first intermediate turn 112 facing that outer side, and a boundary surface 80b exists at the contact portion as a line boundary. Likewise, a first insulator portion 8210 in contact with the outer side (X2 side in X1-X2 direction) of the second inner-side turn 211 includes two parts in contact with a first insulator portion 822i, which is in contact with the inner side (X1 side in X1-X2 direction) of the second intermediate turn 212 facing that outer side, and a boundary surface 80b exists at the contact portion as a line boundary. In addition, the two contact parts form a pore 80p that becomes a closed space. Such boundary surfaces 80b and pores 80p can absorb the displacement of the coil member 10 when the coil member 10 thermally expands due to heat generated when the coil component 100 is in operation, and can reduce the stress applied to the magnetic powder in the main body portion 30 near the coil member 10, which is prone to magnetic saturation. Therefore, the boundary surfaces 80b and pores 80p can improve the DC superimposed rated current of the electronic component.

Furthermore, a first connection part 801 is present for each of the first inner-side turn 111 and the first intermediate turn 112, and these two first connection parts 801 are in contact with each other at the boundary surface 80b. An intermediate part 80i is present between the first inner-side turn 111 and the second inner-side turn 211, and an intermediate part 80i is also present between the first intermediate turn 112 and the second intermediate turn 212. All of these intermediate parts 80i are integrated with the first connection part 801.

### Second Example

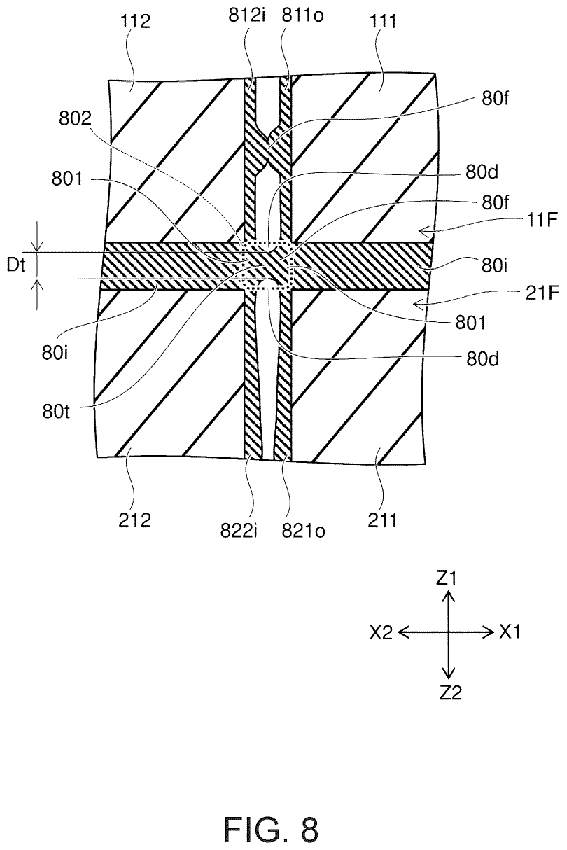

FIG. 8 is a schematic diagram illustrating a detailed structure (second example) of a first insulator portion included in a coil component according to an embodiment of the present invention. In the second specific example, a first insulator portion 80 in contact with one of two opposite side parts in two turns is integrated with a first insulator portion 80 in contact with the other of the two side parts, and two first connection parts 801 present in the two turns are integrated with each other.

Specifically, a first insulator portion 8110 in contact with the outer side (X2 side in X1-X2 direction) of the first inner-side turn 111 includes one part integrated with a first insulator portion 812i, which is in contact with the inner side (X1 side in X1-X2 direction) of the first intermediate turn 112 facing that outer side, and the integrated part is a fusion part 80f.

Furthermore, a first connection part 801 is present for each of the first inner-side turn 111 and the first intermediate turn 112, and these two first connection parts 801 are integrated with the fusion part 80f. An intermediate part 80i is present between the first inner-side turn 111 and the second inner-side turn 211, and an intermediate part 80i is also present between the first intermediate turn 112 and the second intermediate turn 212. All of these intermediate parts 80i are integrated with the first connection parts 801.

In other words, at least one of the two first connection parts 801 includes at least one of a part in contact with the part (first counterpart 11F) facing to the first spiral conductor portion 11 and a part in contact with the part (second counterpart 21F) facing the second spiral conductor portion 21. In FIG. 8, each of the two first connection parts 801 includes the part in contact with the part (first counterpart 11F) facing to the first spiral conductor portion 11 and the part in contact with the part (second counterpart 21F) facing the second spiral conductor portion 21.

The first insulator portion 80, which includes two first connection parts 801 with fusion parts 80f shown in FIG. 8, has a part in contact with one of the two turns (e.g., the first inner-side turn 111), a part in contact with the other of the two turns (the first intermediate turn 112), and a second connection part 802 (area surrounded by dotted lines in FIG. 7), which is connected to these parts and extends in a direction (X1-X2 direction in FIG. 8) that intersects the first direction (Z1-Z2 direction). The second connection part 802 includes a portion including the fusion parts 80f in the two first insulator portions 80.

The second connection part 802 has a thinned part 80t in the first insulator portion 80, which is thinner in the first direction (Z1-Z2 direction) than the part in contact with either of the two turns. It is preferable in some cases that the thickness Dt of the thinned part 80t in the first direction (Z1-22 direction) is designed to have a ratio to the thickness of the other portion of the second connection part 802 in the first direction (Z1-Z2 direction) equal to or greater than 0.6. In these cases, the thinned part 80t forms a recess 80d, and it is easy to make a ratio of the depth of the recess 80d to the thickness of the other portion of the second connection portion 802 in the first direction (Z1-Z2 direction) equal to or lower than 0.2.

### Third Example

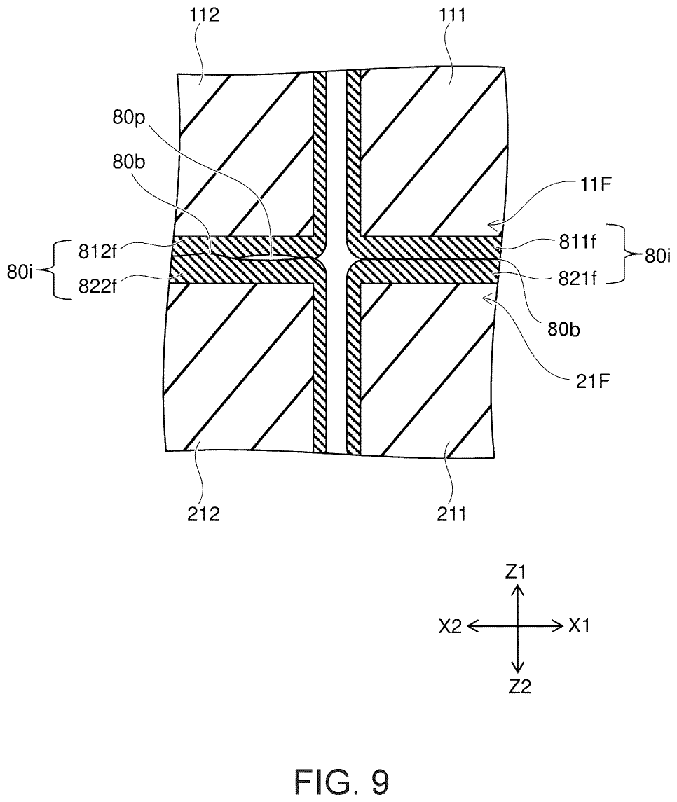

FIG. 9 is a schematic diagram illustrating a detailed structure (third example) of a first insulator portion included in a coil component according to an embodiment of the present invention. The intermediate parts 801 of the first insulator portion 80 shown in FIG. 7 and FIG. 8 are provided between and integrated with the first spiral conductor portion 11 and the second spiral conductor portion 21 so as to connect to both of them, but the intermediate parts 80i shown in FIG. 9 are not integrated. Specifically, the intermediate part 80i has an opposing contact part 811f in contact with the first counterpart 11F of the first inner-side turn 111 and an opposing contact part 821f in contact with the second counterpart 21F of the second inner-side turn 211, and a boundary surface 80b exists between them. In addition, the intermediate part 80i has an opposing contact part 812f in contact with the first counterpart 11F of the first intermediate turn 112 and an opposing contact part 822f in contact with the second counterpart 21F of the second intermediate turn 211, and a boundary surface 80b also exists between them. Furthermore, there exist air pores 80p.

### Fourth Example

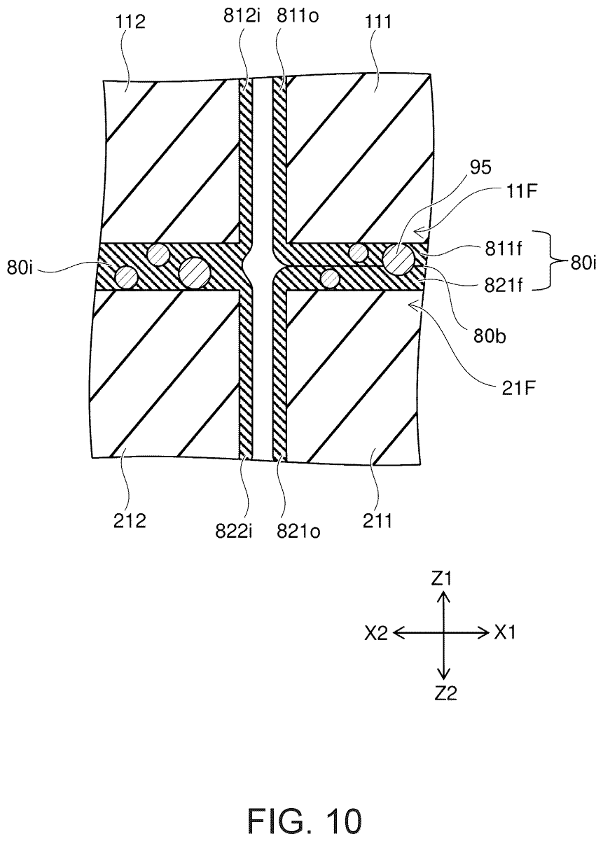

FIG. 10 is a schematic diagram illustrating a detailed structure (fourth example) of a first insulator portion included in a coil component according to an embodiment of the present invention. In the fourth example, insulating particles 95 such as oxide-based particles are present between the first spiral conductor portion 11 and the second spiral conductor portion 21. Specific examples of the insulating particles 95 include inorganic materials such as oxides, carbides, nitrides, and inorganic salts. For example, oxides include silica, alumina, and zirconia. For example, carbides and nitrides include silicon carbide and boron nitride, respectively. For example, inorganic salts include silicates, phosphates, borates, and carbonates. For example, such inorganic salts include minerals such as wollastonite, kaolin, and mica, among which oxide-based materials such as oxides, silicates, and phosphates are preferred in terms of insulation. For example, it is preferred that the insulating particles 95 include at least one selected from the group consisting of silicon (Si), phosphorus (P), boron (B), and calcium (Ca). The shape of the insulating particles 95 is not particularly limited as long as it can be positioned between the first spiral conductor portion 11 and the second spiral conductor portion 21. The shape may be a shape close to a sphere, a shape with a large aspect ratio such as a needle, or an indefinite shape. When observing a cross section between the first spiral conductor portion 11 and the second spiral conductor portion 21, it is preferable in some cases that the average equivalent circular diameter (ECD) of the insulating particles 95 is ranged between 0.0010 μm and 2.5 μm. The average equivalent circular diameter is more preferably 0.020 μm or more, and even more preferably 0.050 μm or more. Moreover, the average equivalent circular diameter is more preferably 2.0 μm or less, and even more preferably 1.5 μm or less. From the viewpoint of contributing to ensuring insulation between the first spiral conductor portion 11 and the second spiral conductor portion 21 even during the manufacturing process of the coil component 100, the insulating particles 95 are preferably hard. From the same viewpoint, the insulating particles 95 are preferably made of an inorganic material rather than an organic material.

### Modification

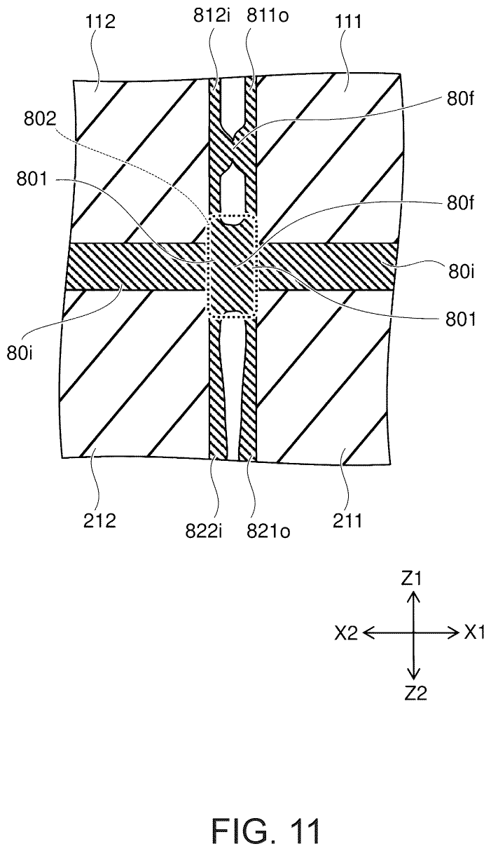

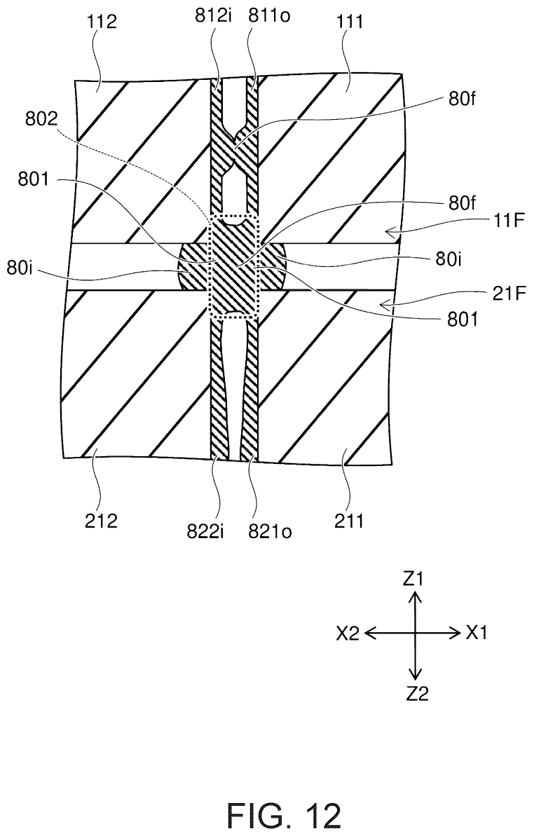

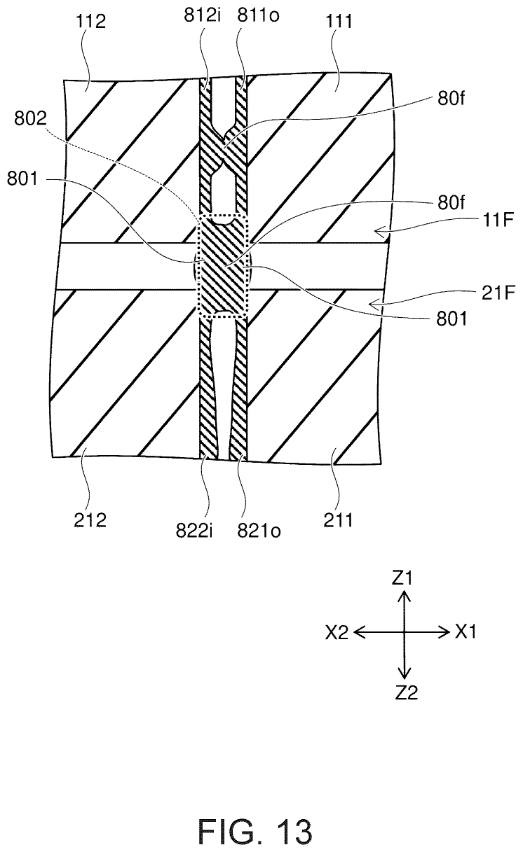

FIGS. 11-13 are schematic diagrams illustrating a detailed structure (Modifications 1-3 of second example) of a first insulator portion included in a coil component according to an embodiment of the present invention. In Modification 1 shown in FIG. 11, the fusion part 80f based on the first connection part 801 extends between the side of the first inner-side turn 111 and the side of the first intermediate turn 112 and between the side of the second inner-side turn 211 and the side of the second intermediate turn 212. As a result, the second connecting part 802 extends in the first direction (Z1-22 direction). The two ends of the second connection part 802 may extend to the first back counterpart 11FA and the second back counterpart 21FA, respectively. In Modification 2 shown in FIG. 12, the amount of the intermediate parts 80i is less than that provided in Modification 1, and the first counterpart 11F and the second counterpart 21F include portions that are not in contact with the first insulator portion 80. In Modification 3 shown in FIG. 13, the first insulator portion 80 does not have any portion in contact with the first counterpart 11F and the second counterpart 21F. In a case the first insulator portion 80 is not present between the first counterpart 11F and the second counterpart 21F as in FIG. 12 and FIG. 13, it is preferable that insulating particles 95 are provided in lieu of the first insulator portion 80 to avoid possible short circuit between the first spiral conductor portion 11 and the second spiral conductor portion 21.

### Second Embodiment

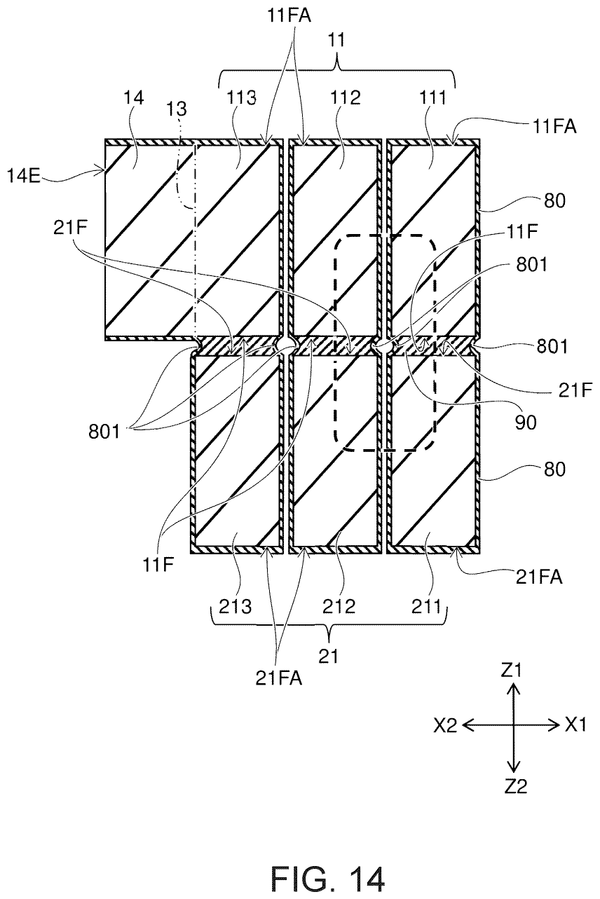

FIG. 14 is a cross-sectional view on an XZ plane for illustrating a second embodiment of a first insulator portion included in a coil component according to an embodiment of the present invention. In the second embodiment, in comparison with the first embodiment, a second insulator portion 90 formed of a material different from the material forming the first insulator portion 80 is disposed at least partially between the first spiral conductor portion 11 and the second spiral conductor portion 21 for all turns shown in FIG. 14.

The second insulator portion 90 is in contact with at least one of the first spiral conductor portion 11 and the second spiral conductor portion 21, and in FIG. 14, in contact with both. In a specific example, the second insulator portion 90 includes polyimide resin. Also, for example, the second insulator portion 90 may be at least one selected from the group consisting of organic materials such as polyimide resin, polyethylene resin, epoxy resin, and phenolic resin, inorganic materials such as cellulose, glass, alumina, aluminum, magnesium, and calcium carbonate, and composite materials of organic and inorganic materials.

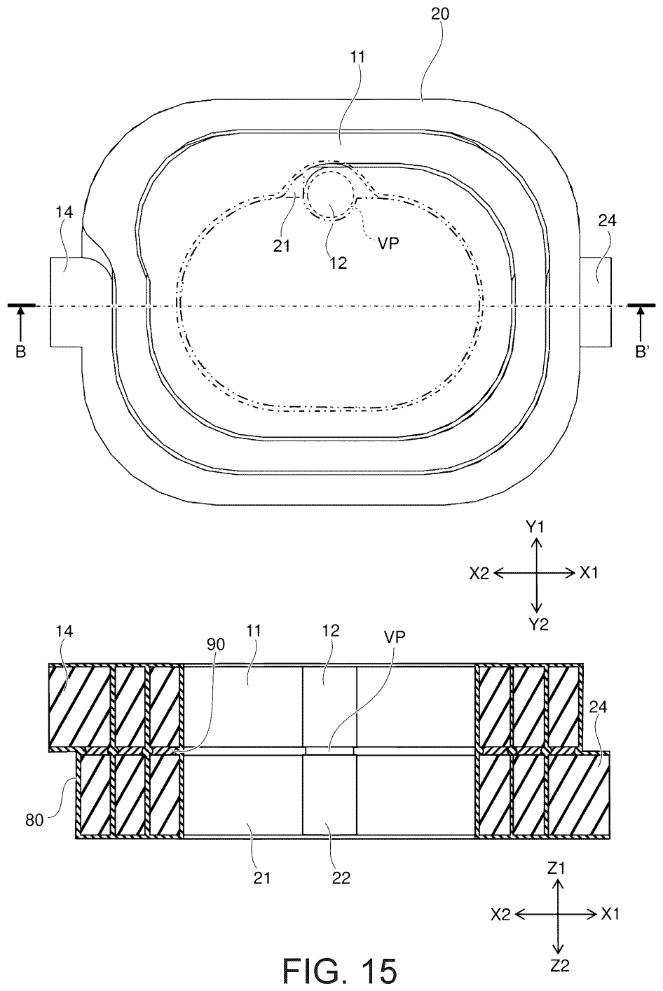

FIG. 15 is an XY plan view and a cross-sectional view in the XZ plane (XZ cross-sectional view) for illustrating the first insulator portion according to the second embodiment. The XZ cross-sectional view is a cross-sectional view taken along line B-B′ in the XY plan view. In the XZ cross-sectional view, elements except for the coil conductor portion 20 are seen through. When viewed in the first direction (Z1-22 direction), an envelope (shown as chain line in FIG. 15) of an inner edge of the second insulator portion 90, which is in contact with a turn constituting the inner edge of the first spiral conductor portion 11, i.e., the first inner-side turn 111 located in the innermost position, incorporates the inner edge of the first spiral conductor portion 11 (shown as two-dot chain line in FIG. 15). The position of the inner edge of the second insulator portion 90 is defined as the average of the positions across the thickness dimension of the second insulator portion 90. Furthermore, the second insulator portion 90 is not disposed in a portion of the second spiral conductor portion 21, which does not overlap with the first spiral conductor portion 11 near the via member VP when viewed from the Z1 side in the Z1-22 direction, and also not disposed in a portion of the first spiral conductor portion 11, which does not overlap with the second spiral conductor portion 21 near the via member VP when viewed from the Z2 side in the Z1-22 direction.

Therefore, the envelope of the inner edge of the second insulator portion 90 passes outside the via member VP (hidden line), which is disposed in overlap with the end part 12 when viewed in the first direction.

### (Main Body)

The main body portion 30 contains magnetic powder and contains partially the coil member 10. In this embodiment, the main body portion 30 has a substantially rectangular parallelepiped shape and contains portions except for the outermost end face (X2 side in X1-X2 direction) of the first lead part 14 and the outermost end face (X1 side in X1-X2 direction) of the second lead part 24, which are disposed at ends of the coil member 10.

The structure of the magnetic powder is not limited. This structure may include a crystalline phase or an amorphous phase. Herein, a crystalline material is defined as a material formed of a crystalline phase, an amorphous material is defined as a material formed of an amorphous phase, and a composite material is defined as a material including a crystalline material and an amorphous material. In a situation that the diffraction spectrum obtained by a general X-ray diffraction method includes a sharp diffraction peak that can identify the type of crystalline phase, the material includes a crystalline phase. On the other hand, in the situation that the diffraction spectrum obtained by a general X-ray diffraction method includes a broad peak indicating an amorphous phase, the material includes an amorphous phase. If the DSC curve obtained by differential thermal analysis includes a peak indicating crystallization, i.e., heat generation associated with a phase change from an amorphous phase to a crystalline phase, the material includes an amorphous phase.

The material system of the magnetic powder is not limited. Specific examples of the crystalline material include Fe—Si—Cr based alloys, Fe—Ni based alloys, Fe—Co based alloys, Fe—V based alloys, Fe—Al based alloys, Fe—Si based alloys, Fe—Si—Al based alloys, iron only, and ferrite. It is preferable to use carbonyl iron powder as iron-only powder. Specific examples of the amorphous material include Fe—Si—B based alloys, Fe—P—C based alloys, and Co—Fe—Si—B based alloys. Specific examples of composite materials include Fe—Zr based alloys, Fe—Zr—B based alloys, Fe—Si—B—Nb—Cu based alloys, and Fe—Si—B—P—Cu based alloys. If the magnetic powder is metal powder containing Fe, the synergistic effect on improvement of magnetic properties is particularly significant.

The chemical composition of the magnetic powder is not limited. For example, the Fe—Si—Cr based alloy may be composed of 1.0-10.0 mass % Si, 1.0-10.0 mass % Cr, and the remainder composed of Fe and impurities. Also, for example, the Fe—Ni based alloy may be composed of 1.0-99.0 mass % Ni, and the remainder composed of Fe and impurities. Furthermore, for example, the Fe—P—C based alloy may be composed of 1.0-13.0 atom % P, 1.0-13.0 atom % C, Fe, and impurities. The Fe—P—C based alloy may contain one or more optional elements selected from the group consisting of Ni, Sn, Cr, B, and Si. In this case, for example, the amount of Ni may be 0 to 10.0 atomic %, the amount of Sn may be 0 to 3.0 atom %, the amount of Cr may be 0 to 6.0 atom %, the amount of B may be 0 to 9.0 atom %, and the amount of Si may be 0 to 7.0 atom %. The amount of Fe is preferably 65 atom % or more. Also, for example, the Fe—Si—B—Nb—Cu based alloy may be composed of 1.0 to 16.0 atom % Si, 1.0 to 15.0 atom % B, 0.50 to 5.0 atom % Nb, 0.50 to 5.0 atom % Cu, and the balance consisting of Fe and impurities. In this case, the amount of Fe is preferably 65 atom % or more.

The shape of the magnetic powder is not limited. The magnetic powder may be spherical, elliptical, scaly, or of an irregular shape. The manufacturing method for rendering these shapes is also not limited.

The particle size distribution of the magnetic powder is not limited. The particle size distribution of the magnetic powder can be obtained, for example, by analyzing an image (secondary electron image), which is an image of a cut surface of the main body portion 30 obtained with a scanning electron microscope. For example, the average equivalent circular diameter (ECD) of the magnetic powder may be 0.50 to 50.0 μm. The distribution of the equivalent circular diameter (ECD) may include multiple peaks.

The magnetic powder may be subjected to a surface insulating treatment. Provided that the magnetic powder is subjected to a surface insulating treatment, the insulation resistance of the main body portion 30 is improved. There is no limitation on the type of surface insulating treatment applied to the magnetic powder. Examples include phosphoric acid treatment, phosphate treatment, and oxidation treatment. The magnetic powder may have an insulating coating on the surface of the magnetic particles. This insulating coating may contain at least one selected from a group consisting of Si, P, and B, and O (oxygen).

The magnetic powder may be a mixed material in which multiple powder materials are mixed. This magnetic powder is preferably a ferromagnetic material, and more preferably a soft magnetic material.

The main body portion 30 may further include an optional auxiliary material. The optional auxiliary material is, for example, a binder material or a modifier. The binder material bonds particles such as magnetic powder contained in the main body portion 30 together. This binder material is preferably an insulating material to impart insulation resistance to the main body portion 30.

The binding component may be an organic material or an inorganic material. The organic material may be a resin material. Examples of the resin material include acrylic resin, silicone resin, epoxy resin, phenol resin, urea resin, melamine resin, and polyester resin. The inorganic material may be a glass-based material such as water glass. The binding material may be a product of a reaction such as thermal decomposition, or may be a mixture of multiple materials.

The modifier, for example, improves the mobility of the powder or adjusts the curing speed of the binder material. The modifier may be a glass-based material.

The dimension of the main body portion 30 is not limited. For example, the maximum dimension of the main body portion 30 may be 3.2 mm or less.

### (External Terminal)

As shown in FIG. 2, the outermost (X2 side in X1-X2 direction) end face (first lead part end face 14E) of the first lead part 14 and the outermost (X1 side in X1-X2 direction) end face of the second lead part 24 (second lead part end face 24E), which are disposed at ends of the coil member 10, are exposed from side surfaces aligned in the X1-X2 direction in the main body portion 30. A first terminal member 41 is provided to be in electric contact with the exposed first lead part end face 14E, and a second terminal member 42 is provided to be in electric contact with the exposed second lead part end face 24E.

The first terminal member 41 has a side portion 41a covering the side surface of the main body portion 30 on the X2 side in the X1-X2 direction, and a bottom portion 41b provided to cover partially the bottom surface (surface on Z2 side in Z1-22 direction) of the main body portion 30. The bottom portion 41b of the first terminal member is a part facing the board when in use. The second terminal member 42 has a side portion 42a covering the side surface of the main body portion 30 on the X1 side in the X1-X2 direction, and a bottom portion 42b provided on the bottom surface of the main body portion 30 to cover partially the bottom surface while being spaced apart from the bottom portion 41b. The bottom portion 42b of the second terminal member also faces the board when in use.

The positions of the first terminal member 41 and the second terminal member 42 are not limited to the positions described above. The first terminal member 41 and the second terminal member 42 may also be formed to cover partially the upper surface of the main body portion 30. The first terminal member 41 and the second terminal member 42 may also be provided on only partially the bottom surface of the main body portion 30. In this case, the coil conductor portion 20 may include a connecting conductor (not shown), which connects the two ends (first lead part 14 and second lead part 24) of the coil member 10 to the bottom surface of the main body portion 30 through the inside of the main body portion 30. In this case, the two ends (first lead part 14 and second lead part 24) of the coil member 10 may not be exposed from the side surface of the main body portion 30, while the connecting conductor may be exposed from the bottom surface of the main body portion 30.

The material and configuration of the first terminal member 41 and the second terminal member 42 are not limited as long as they have appropriate conductivity. One non-limiting example of the first terminal member 41 and the second terminal member 42 is a layer having a structure of Cu plating/Ni plating/Sn plating from the side proximal to the surface of the main body portion 30. The first terminal member 41 and the second terminal member 42 may be composed of a coated electrode, in which a conductive material such as silver is dispersed in a resin or the like. The first terminal member 41 and the second terminal member 42 may also be a combination of plated layer and coated electrode.

### (Outer Cover)

The upper surface of the main body portion 30 (surface on Z1 side in Z1-Z2 direction) and the side surfaces in the Y1-Y2 direction are each provided with an insulating outer cover 50, 60. An insulating outer cover may also be provided on a portion of the bottom surface of the main body portion 30, where the bottom surface portions 41b and 42b are not provided. Furthermore, the coil component 100 may not be provided with the outer cover 50, 60. The outer covers 50 and 60 can be formed at any position on the surface of the main body portion 30 depending on practical requirements.

### (Manufacturing Method)

The manufacturing method of the coil component according to this embodiment is not particularly limited. One non-limiting example of the manufacturing method is as follows.

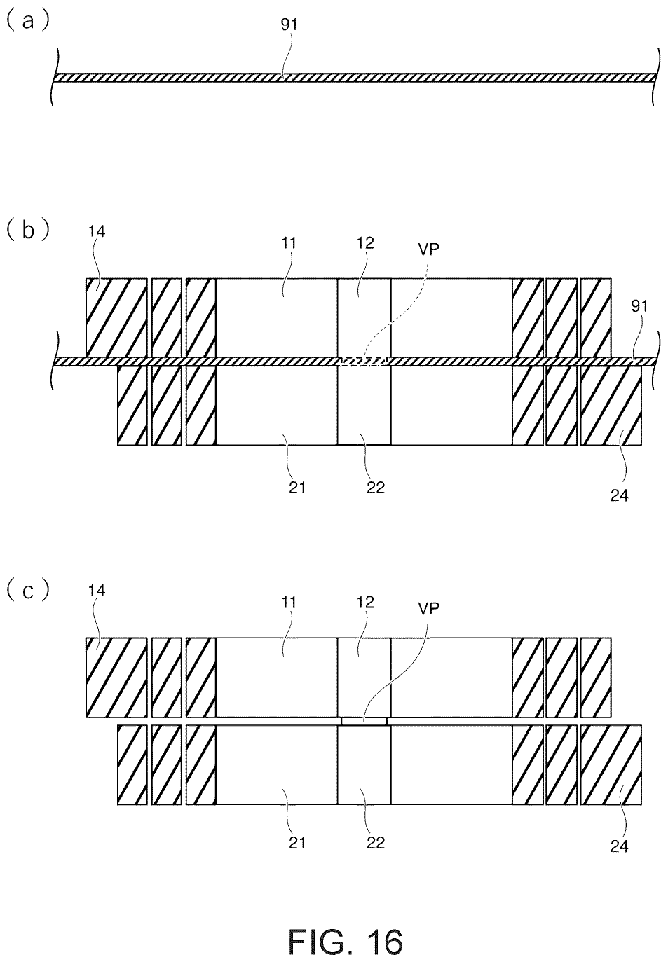

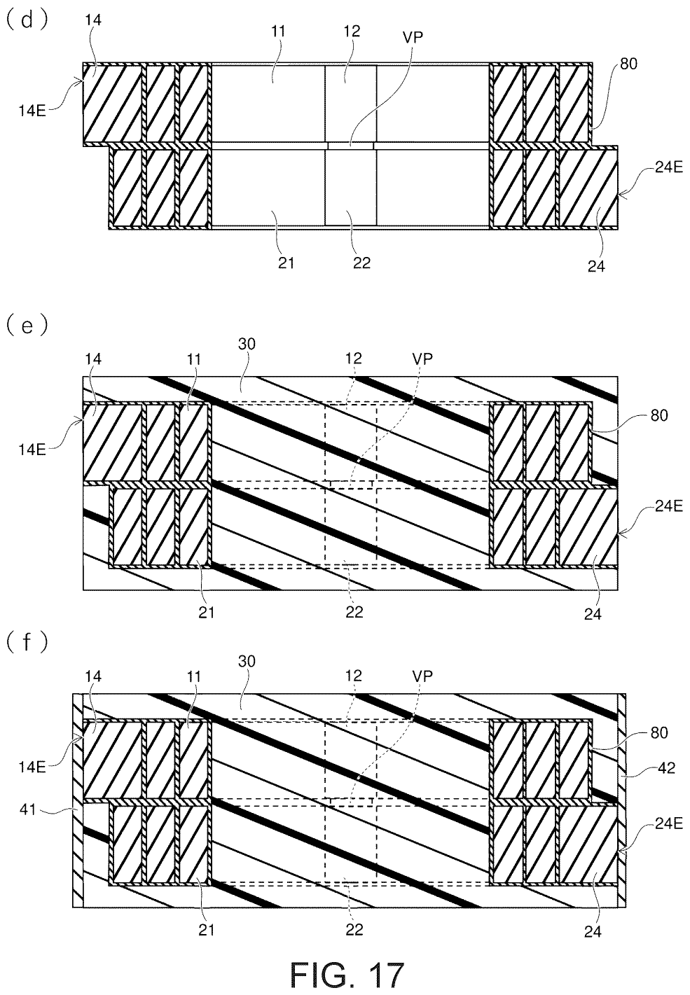

FIG. 16 is a schematic diagram (former half) illustrating a method for manufacturing a coil component according to an embodiment of the present invention. FIG. 17 is a schematic diagram (latter half) illustrating a method for manufacturing a coil component according to an embodiment of the present invention. The method for manufacturing the coil component 100 according to this embodiment includes the first step to the third steps described below, and further includes the fourth step and the fifth step as a more preferred specific example.

In the first step, a first spiral conductor portion 11 is formed on one surface, e.g., the surface on the Z1 side in the Z1-22 direction, of an insulating sheet substrate 91 shown FIG. 16(a), and a second spiral conductor portion 21 is formed on the other surface, e.g., the surface on the Z2 side in the Z1-Z2 direction, of the sheet substrate 91 (FIG. 16(b)). The formation process of the first spiral conductor portion 11 and the second spiral conductor portion 21 is not particularly limited. For example, they can be formed by a plating process. In this embodiment, in this formation process, the via member VP and the first lead part 14 and the second lead part 24 are also formed at the same time.

The sheet substrate 91 is not particularly limited as long as it has mechanical properties to function as a support when forming the first spiral conductor portion 11 and the second spiral conductor portion 21, and has suitable features (removability) for the second step to be described below. Examples of materials constituting the sheet substrate 91 include organic materials, inorganic materials, and composite materials thereof. Specific examples of organic materials include thermoplastic resins such as polyimide and polyethylene, thermosetting resins such as epoxy resins and phenolic resins, and cellulose. Specific examples of inorganic materials include oxide-based materials such as glass and alumina, metal-based materials such as aluminum and magnesium, and inorganic salt-based materials such as calcium carbonate. Specific examples of composite materials include a structure in which an inorganic material is dispersed in a matrix of an organic material.

In the second step, as shown in FIG. 16(c), at least a portion of the sheet substrate 91 is removed. FIG. 16(c) shows a case that the entire sheet substrate 91 is removed. The specific removal process is appropriately set according to the constituent material of the sheet substrate 91. The removal process is broadly classified into a dry process such as plasma etching and a wet process such as wet etching. From the viewpoint of enhancing the efficiency of removing the sheet substrate 91, a wet process may be preferable. A portion of the sheet substrate 91 may be removed by the removal process, and a remaining portion may remain unremoved. For example, the sheet substrate 91 may be made of a composite material of an organic material and an inorganic material, and only the organic material may be removed by the removal process.

In the third step, as shown in FIG. 17(d), a first insulator portion 80 is formed to be in contact with the exposed surfaces of the first spiral conductor portion 11 and the second spiral conductor portion 21. The formation process of the first insulator portion 80 is appropriately set according to the constituent material of the first insulator portion 80. For example, when the first insulator portion 80 is made of a paraxylylene-based polymer, it is formed by a dry process (CVD). When the first insulator portion 80 contains a curable resin material such as an epoxy resin, it can be formed by attaching a powder or liquid containing the constituent material of the first insulator portion 80 to the exposed surface, and then solidifying the attached material by heating, etc.

In this example, as shown in FIG. 17(d), the first insulator portion 80 is not provided on a portion of the first lead part 14 of the coil member 10, specifically the outermost (X2 side in X1-X2 direction) end face (first lead part end face 14E) in this embodiment, and a portion of the second lead part 24, specifically the outermost (X1 side in X1-X2 direction) end face (second lead part end face 24E) in this embodiment. The portion where the first insulator portion 80 is not provided (exposed end face) can be formed by, for example, masking. Alternatively, the exposed end faces may also be formed by providing a continuous dummy member to cover the first lead part end face 14E and the second lead part end face 24E, and forming the first insulator portion 80 on the surface of the dummy member. The dummy member is then cut to expose the first lead part end face 14E and the second lead part end face 24E.

In the fourth step, as shown in FIG. 17(e), portions of the first lead part 14 and the second lead part 24 in the coil member 10 (in this embodiment, as a specific example, the portions except for the first lead part end face 14E and the second lead part end face 24E) are sealed with a material containing magnetic powder to form the main body portion 30. The method for forming the main body portion 30 is not limited, and a molding process is exemplified. Specific examples of the molding process include placing the product of the third step in a mold, and compression molding the product with the material containing magnetic powder, or transfer molding the material containing magnetic powder or a component that is a raw material of that material.

The method of forming the main body portion 30, from which the first lead part end face 14E and the second lead part end face 24E are exposed, is not limited. For example, the first lead part end face 14E and the second lead part end face 24E may be masked before forming the main body portion 30. Alternatively, a continuous dummy member may be provided in advance to cover the first lead part end face 14E and the second lead part end face 24E, and the first insulator portion 80 is formed on the surface of the dummy member. After the main body portion 30 is formed, the dummy member is cut to expose the first lead part end face 14E and the second lead part end face 24E.

In the fifth step, as shown in FIG. 17(f), one of the two terminal members (first terminal member 41) is electrically connected to the position of the first lead part 14 (first lead part end surface 14E), which is not sealed with the material containing magnetic powder in the fourth step, and the other of the two terminals (second terminal member 42) is electrically connected to the position of the second lead part 24 (second lead part end surface 24E). The method of forming the first terminal member 41 and the second terminal member 42 is not limited, and examples include a plating process, a printing process, etc.

### (Electronic/Electric Device)

The electronic/electrical device according to one embodiment of the present invention is an electronic/electric device in which the coil component 100 according to one embodiment of the present invention is installed. The coil component 100 is connected to a board with the first terminal member 41 and the second terminal member 42. The electronic/electric device according to an embodiment of the present invention can be easily miniaturized because it is mounted with the coil component 100 according to an embodiment of the present invention. Furthermore, even if a large current passes through the device or a high frequency is applied, malfunctions caused by deterioration of the function of the coil component 100 or heat generation are unlikely to occur.

The above-described embodiments and examples are described to facilitate understanding of the present invention, and are not described to limit the present invention. Therefore, each element disclosed in the above embodiments and examples is intended to include all design modifications and equivalents that fall within the technical scope of the present invention.

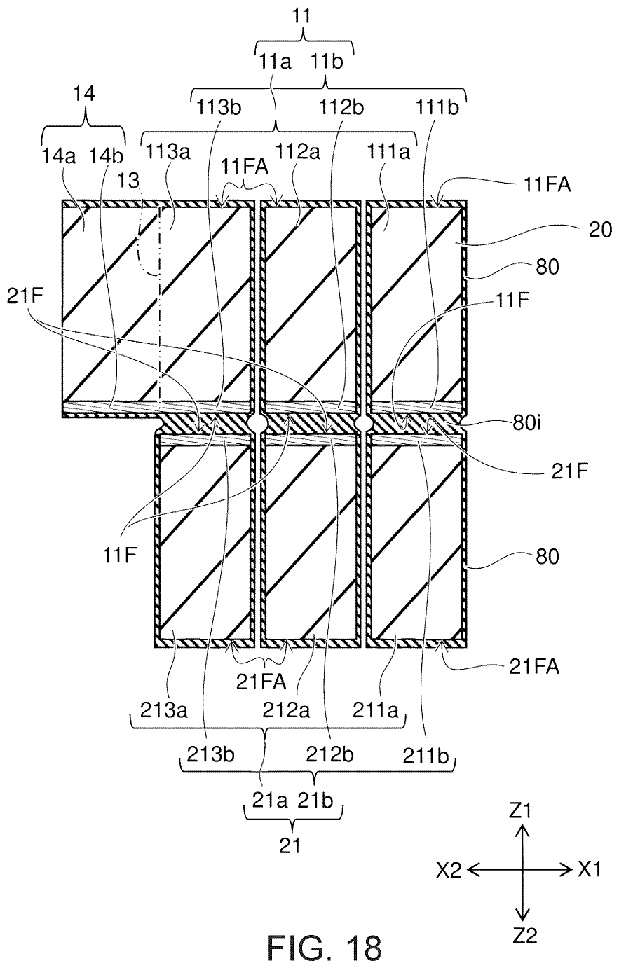

For example, in the above description, the coil conductor portion 20 is composed of one type of conductive material, but not limited thereto. It may be composed of multiple kinds of materials. FIG. 18 is a schematic diagram illustrating a structure of a modified coil conductor portion included in a coil component according to one embodiment of the present invention. In FIG. 18, similar to FIG. 6, only a cross section in the XZ cross section of the coil component 100 taken along line A-A′ is shown. As shown in FIG. 18, the first spiral conductor portion 11 constituting the coil conductor portion 20 is composed of a first conductor portion 11a and a second conductor portion 11b, wherein the second conductor portion 11b is disposed at a side of the first conductor portion 11a facing the second spiral conductor portion 21 (Z2 side in Z1-22 direction), i.e., the first counterpart 11F. In FIG. 18, the first inner-side turn 111 consists of a first conductor portion 111a and a second conductor portion 111b, the first intermediate turn 112 consists of a first conductor portion 112a and a second conductor portion 112b, and the first outer-side turn 113 consists of a first conductor portion 113a and a second conductor portion 113b.

Likewise, the second spiral conductor portion 21 constituting the coil conductor portion 20 is composed of a first conductor portion 21a and a second conductor portion 21b, wherein the second conductor portion 21b is disposed at a side of the first conductor portion 21a facing the first spiral conductor portion 11 (Z1 side in Z1-22 direction), i.e., the second counterpart 21F. In FIG. 18, the second inner-side turn 211 is composed of a first conductor portion 211a and a second conductor portion 211b, the second intermediate turn 212 is composed of a first conductor portion 212a and a second conductor portion 212b, and the second outer-side turn 213 is composed of a first conductor portion 213a and a second conductor portion 213b. Furthermore, the first lead part 14 constituting the coil conductor portion 20 is composed of a first conductor portion 14a and a second conductor portion 14b, wherein the second conductor portion 14b is disposed at a side of the first conductor portion 14a close to the second spiral conductor portion 21 in the first direction (Z1 side in Z1-Z2 direction). Although not shown in the drawings, the second lead part 24 is also composed of a first conductor portion and a second conductor portion. Examples of the constituent materials of the first conductor portions 11a, 21a, and 14a include conductive materials such as copper, copper alloys, aluminum, and aluminum alloys, and examples of the constituent materials of the second conductor portions 11b, 21b, and 14b include conductive materials such as materials containing Ni and Cr. With the second conductor portions 11b and 21b, the smoothness of the first counterpart 11F of the first spiral conductor portion 11 and the smoothness of the second counterpart 21F of the second spiral conductor portion 21 can be improved.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A coil component, comprising:
a coil member, comprising:
a first spiral conductor portion and a second spiral conductor portion, aligned with each other in a first direction; and
a first insulator portion, comprising:
a part in contact with a back counterpart of the first spiral conductor portion, which is opposite to the second spiral conductor portion;
a part in contact with a back counterpart of the second spiral conductor portion, which is opposite to the first spiral conductor portion;
a part in contact with a side part of the first spiral conductor portion along a spiral direction thereof; and
a part in contact with a side part of the second spiral conductor portion along a spiral direction thereof;
wherein the first insulator portion comprises a first connection part disposed to connect a part in contact with a side part of a first turn of the first spiral conductor portion and a part in contact with a side part of a second turn of the second spiral conductor portion, which is closest to the side part of the first turn.

2. The coil component according to claim 1, further comprising:
a main body portion comprising a magnetic powder and covering at least partially the coil member; and
two terminal members electrically connected to two end parts of the coil member, respectively,
wherein the coil member comprises the first spiral conductor portion and the second spiral conductor portion and has a conductive coil conductor portion,
wherein the coil conductor portion comprises:
a via member disposed between an end part of the first spiral conductor portion and an end part of the second spiral conductor portion to be in contact with the end part of the first spiral conductor portion and the end part of the second spiral conductor portion;
a first lead part electrically connected one of the two terminal members to another end part of the first spiral conductor portion; and
a second lead part electrically connected the other of the two terminal members to another end part of the second spiral conductor portion.

3. The coil component according to claim 1, wherein the first insulator portion comprises:
a part in contact with a counterpart of the first spiral conductor portion, which faces the second spiral conductor portion; and
a part in contact with a counterpart of the second spiral conductor portion, which faces the first spiral conductor portion.

4. The coil component according to claim 2, wherein the first insulator portion is in contact with a portion of the coil conductor portion, which is located inside the main body portion.

5. The coil component according to claim 1, wherein:
at least one of the first spiral conductor portion and the second spiral conductor portion comprises two turns aligned with each other in a direction intersecting the first direction, and
the first insulator portion in contact with one of the two opposing side parts of the two turns and the first insulator portion in contact with the other of the two opposing side parts are in contact with each other or integrated.

6. The coil component according to claim 1, wherein:
each of the first spiral conductor portion and the second spiral conductor portion comprises two turns aligned with each other in a direction intersecting the first direction,
the first connection part exists in each of the two turns, and
the two first connection parts existing in the two turns are in contact with each other with a boundary or integrated with each other.

7. The coil component according to claim 6, wherein at least one of the two first connection parts comprises at least one of a part connected to a counterpart of the first spiral conductor portion and a part connected to the counterpart of the second spiral conductor portion.

8. The coil component according to claim 1, wherein the first insulator portion comprises a thermoplastic resin and is thermoplastic.

9. The coil component according to claim 8, wherein the thermoplastic resin comprises a paraxylylene-based polymer.

10. The coil component according to claim 1, wherein for the first insulator portion:
a volume resistivity measured according to ASTM D257 is 1.0×10¹⁴ Ωcm or more; and
a relative dielectric constant at 60 Hz measured according to ASTM D150 is 4.0 or less.

11. The coil component according to claim 1, wherein oxide-based particles are present between the first spiral conductor portion and the second spiral conductor portion.

12. The coil component according to claim 11, wherein the oxide-based particles have an average equivalent circular diameter ranged between 0.0010 μm and 2.5 μm when viewed from a cross section between the first spiral conductor portion and the second spiral conductor portion.

13. The coil component according to claim 1, wherein an average clearance between the first spiral conductor portion and the second spiral conductor portion is ranged between 1.0 μm and 20 μm.

14. The coil component according to claim 1, wherein for the first insulator portion, an average thickness ranged between 1.0 μm and 10 μm is obtained by operating:
a thickness of a portion of the first spiral conductor portion in contact with a back counterpart of the second spiral conductor portion;
a thickness of a portion of the second spiral conductor portion in contact with an opposite side of the first spiral conductor portion;
a thickness of a portion of the first spiral conductor portion in contact with a side part of the second spiral conductor portion; and
a thickness of a portion of the second spiral conductor portion in contact with a side part of the first spiral conductor portion.

15. The coil component according to claim 1, wherein:
at least one of the first spiral conductor portion and the second spiral conductor portion comprises two turns aligned with each other in a direction intersecting the first direction, and
the first insulator portion comprises:
a specified portion in contact with one of the two turns;
a specified portion in contact with the other of the two turns; and
a second connection part continuously extending from the specified portions in the direction intersecting the first direction, and
the second connection part has a thinned part, which is thinner, in the first direction, than the specified portion of the first insulator portion in contact with either of the two turns.

16. The coil component according to claim 1, wherein:
at least one of the first spiral conductor portion and the second spiral conductor portion comprises two turns aligned with each other in a direction intersecting the first direction, and
an average width of a gap between the two turns is 0.025 to 0.25 times an average width of the two turns in the direction intersecting the first direction.

17. The coil component according to claim 1, wherein:
the first insulator portion comprises an intermediate part disposed between a turn of the first spiral conductor portion and a turn of the second spiral conductor portion, and
at least one of a boundary surface or air pores exists in the intermediate part.

18. The coil component according to claim 1, wherein:
at least one of the first spiral conductor portion and the second spiral conductor portion comprises two turns aligned with each other in a direction intersecting the first direction, and
the first insulator portion exists in each of the two opposing side parts of the two turns, and at least one of a line boundary and a closed space exists in between the side parts of the two turns and the first insulator portion.

19. The coil component according to claim 1, wherein the first insulator portion in contact with the first spiral conductor portion, for all turns of the first spiral conductor portion, a specified portion in contact with a counterpart facing the second spiral conductor portion, a specified portion in contact with a back counterpart opposite to the second spiral conductor portion, and a specified portion in contact with a side are continuously interconnected without a connection boundary.

20. The coil component according to claim 1, wherein the first insulator portion in contact with a counterpart of the first spiral conductor portion facing the second spiral conductor portion is also in contact with the second spiral conductor portion without a connection boundary.

21. The coil component according to claim 1, wherein a second insulator portion is formed of a material different from the material forming the first insulator portion and is disposed at least partially between the first spiral conductor portion and the second spiral conductor portion.

22. The coil component according to claim 21, wherein the second insulator portion is in contact with at least one of the first spiral conductor portion and the second spiral conductor portion.

23. The coil component according to claim 21, wherein the second insulator portion comprises a polyimide resin.

24. An electronic/electric device, in which the coil component according to claim 2 is installed, wherein the coil component is connected to a board via the terminal members.
